(19) United States
(12) Patent Application Publication
(10) Pub. No.: US 2007/0167604 A1
(43) Pub. Date: Jul. 19, 2007

(54) Method for preparing polyester copolymer containing amide link

(76) Inventors: Jeoung-Jun Hwang, Anyang-si (KR); Jong-Ryang Kim, Suwon-el (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/585,240

(22) PCT Filed: Dec. 31, 2004
(86) PCT No.: PCT/KR04/03551

§ 371 Date: Jun. 29, 2006

(30) Foreign Application Priority Data
Dec. 31, 2003 (KR) 10-2003-0101621

(51) Int. Cl. C08G 63/02

(52) U.S. Cl. 528/272

(57) ABSTRACT

A method for preparing polyester copolymer containing amide link, which can reduce the phase separation of a polyester component and an amide component by improving the compatibility therebetween is disclosed. The method for preparing polyester copolymer comprises the step of polymerizing macrocyclic polyester oligomer and cyclic amide monomer. Wherein, it is preferable that the macrocyclic polyester oligomer is obtained by reacting bis(hydroxyalkyl)ester with dicarboxylic acid chloride in the presence of unhindered amine, and the bis(hydroxyalkyl)ester is obtained by. depolymerizing polyester. resin. Also, lit is preferable that the cyclic amide monomer is E-caprolactam having a cyclic structure and having 2 or more carbon atoms, and the amount of the macrocyclic polyester oligomer is 5 to 99% by weight with respect to total amount of the macrocyclic polyester oligomer and the cyclic amide monomer.

### FIELD OF THE INVENTION

The present invention relates to a method for preparing polyester copolymer containing amide link, and more specifically to a method for preparing polyester copolymer containing amide link, which can reduce the phase separation of a polyester component and an amide component by improving the compatibility therebetween. The polyester copolymer can be used f or various uses by adjusting the species and the amounts of the polyester component and the amide component.

### BACKGROUNDS OF THE INVENTION

Generally, a polyester-based resin and a polyamide-based resin are liable to be phase separated during blending due to their low compatibility. And even when performing esterification reaction by melt-blending, or performing polymerization reaction of their respective monomer, it is difficult to obtain a copolymer having good properties. Also, there might occur the problem that a transparent polyester loses its transparency due to the amide component therein. Accordingly, various researches have been carried out on the preparation of a copolymer having both of their respective desirable properties by increasing the compatibility between a polyester-based resin and a polyamide-based resin. For example, Japanese Patent Laid-open No. S 51-103191 disclosed a method which can improve the mechanical properties of a copolymer by melt blending polybutylene terephthalate(PBT) and nylon 6, and polymerizing them in solid phase. In addition, it is known that a method which can prepare a copolymer by performing ester-amide exchange reaction using p-toluene sulfone(TsOH) during the melt-blending of polyethylene terephthalate(PET) and Nylon 66. Also, as products having the properties of polyester and nylon, MXD6, which is produced by condensation polymerization of MXDA(m-xylenediamine) and adipic acid, is commercially available as gas-blocking material, and X-9, which is an alloy of polyarylate and nylon, is also commercially available as an agent for improving impact resistance.

### SUMMARY OF THE INVENTION

It is an object of the present invention to provide a method for preparing polyester copolymer containing amide link, which can reduce the phase separation by using a polyester component and an amide component having a superior compatibility.

It is other object of the present invention to provide a method for preparing polyester copolymer suitable for various uses, by adjusting the species and the amounts of a polyester component and an amide component.

It is another object of the present invention to provide a method for preparing polyester copolymer containing amide link, which has excellent transparency and is useful in environmental and economical aspect.

To achieve these objects, the present invention provides a method for preparing polyester copolymer containing amide link, wherein the method comprises the step of polymerizing macrocyclic polyester oligomer and cyclic amide monomer. Wherein, it is preferable that the macrocyclic polyester oligomer is obtained by reacting bis(hydroxyalkyl)ester and dicarboxylic acid chloride in the presence of unhindered amine, and the bis(hydroxyalkyl)ester is obtained by depolymerizing a polyester resin. Also, it is preferable that the cyclic amide monomer is ε-caprolactam having a cyclic structure and having 2 or more carbon atoms, and that the amount of macrocyclic polyester oligomer is 5 to 99% by weight with respect to total amount of the macrocyclic polyester oligomer and the cyclic amide monomer.

### DETAILED DESCRIPTION OF THE INVENTION

A more complete appreciation of the invention, and many of the attendant advantages thereof, will be better appreciated by reference to the following detailed description.

The method for preparing polyester copolymer containing amide link according to the present invention, uses macrocyclic polyester oligomer and cyclic amide monomer as reactants. The macrocyclic polyester oligomer used in the present invention includes the repeating unit of the following formula 1.

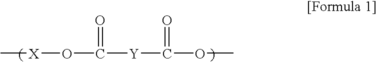

Wherein, X represents alkylene radical or oxyalkylene radical having 2 to 6 carbon atoms, and Y represents aliphatic, aromatic or alicyclic radical, preferably phenylene radical, and the number of the repeating unit in the macrocyclic polyester oligomer used in the present invention, is 1 to 50, preferably 2 to 20, and more preferably 4 to 20.

The macrocyclic poly(alkylene dicarboxylate) oligomer was used as a reactant for polymerization of, a branched-chain polyester (U.S. Pat. No. 5,389,719), and, as disclosed in U.S. Pat. No. 5,231,161, can be obtained by the reaction of bis(hydroxyalkyl) ester such as bis(4-hydroxybutyl)terephthalate with dicarboxylic acid chloride such as terephthaloyl chloride, in the presence of unhindered amine, or in the presence of unhindered amine and tertiary amine such as triethylamine. The bis(hydroxyalkyl)ester used in the preparation of the polyester oligomer, is preferably obtained by a depolymerization reaction, which is a chemical recycling process of polyester resin. Exemplary polyester resin useful in the depolymerization reaction includes molded polyester resin articles, and polyester flakes prepared by crushing the molded polyester resin articles, and polyester waste generated during polyester-molding process or polyester polymerization process. The crushed polyester particles obtained as described above are placed in a reactor, and glycol compound such as ethylene glycol is added in excess amount (an amount of about 100 to 300 weight part with respect to 100 weight part of the crushed polyester particles), and then depolymerization reaction is carried out under high pressure. If desired, some amount of depolymerization catalyst can be added into the reactor. Exemplary. depolymerization catalyst includes various conventional catalysts such as antimony-based catalyst, titanium-based catalyst and germanium-based catalyst, and more preferably titanium-based catalyst. The pressure of the depolymerization reaction depends on the reactor's durability. It is preferable that the pressure is increased to the maximum extent within the admittable range of the reactor, for example 1.5 to 2.5 kgf/cm². Also, the depolymerization can be carried out at the temperature of a conventional polyester polymerization reaction, for example at the range of about 250 to 320° C. Then, the bis(hydroxyalkyl)ester obtained by the depolymerization is added into an organic solvent such as methylene chloride to prepare a solution, and independently a terephthaloyl chloride solution is prepared with an organic solvent such as chlorobenzene. Then, the prepared 2 solutions are added, for 30 to 40 minutes while stirring at the room temperature, into a solution, which is prepared by mixing tertiary amine such as triethylamine and unhindered amine such as 1,4-diazabicyclo octane with methylenechloride. Then the reaction mixture is further stirred for 5 to 10 minutes, filtered, and dried to obtain macrocyclic polyester oligomer. The macrocyclic polyester oligomer, as disclosed in U.S. Pat. No. 5,756,644, can also be obtained in the form of linear polyester polymer by supporting the monomer, which includes the repeating unit of formula 1, on a solid support, and condensation-polymerizing the supported monomer.

The cyclic amide monomer used in the method for preparing polyester copolymer according to the present invention includes amide monomer having a cyclic structure which can perform ring-opening polymerization, specifically amide monomer, having a cyclic structure and having 2 or more carbon atoms, and more specifically ε-caprolactam.

The polymerization of polyester oligomer with amide monomer can be carried out by melting the polyester oligomer under nitrogen atmosphere and by adding amide monomer, if desired, containing a small amount of moisture, and then by stirring the mixture. The amount of the macrocyclic polyester oligomer is 1 to 99%, preferably 5 to 99%, and more preferably 10 to 90% by weight with respect to total amount of the macrocyclic polyester oligomer and the cyclic amide monomer. The weight ratio can be varied according to the desired properties of the copolymer. If the amount of the polyester oligomer is less than 1 weight %, the copolymer having the desired properties of polyester oligomer cannot be obtained. On the other hand, if the amount of the polyester oligomer is more than 99 weight %, the copolymer having the desired properties of amide monomer cannot be obtained. The amide monomer more influences on the properties of copolymer even by the addition of small amount, compared with polyester. The temperature of polymerization of the macrocyclic polyester oligomer with the cyclic amide monomer is 120 to 300° C., and preferably 150 to 260° C. If the reaction temperature is less than 120° C., it is difficult to carry out the reaction. On the contrary, if the reaction temperature is more than 300° C., the heat decomposition might occur. If desired, various conventional polymerization catalyst such as antimony-based catalyst, germanium-based catalyst and titanium-based catalyst, can be used in an amount of 0 to 300 ppm, and preferably 1 to 300 ppm. The reaction atmosphere is nitrogen circulation atmosphere or vacuum, and it can be selected according to the reactor type and the desired degree of polymerization. Reaction time can be controlled according to polymerization reaction apparatus and the desired degree of polymerization.

As described above, generally, a polyester and an amide are different in their respective polymerization reaction mechanism, and the compatibility therebetween is low. Accordingly, it is not easy to copolymerize them. However, macrocyclic polyester oligomer and cyclic amide monomer used in the present invention react via the same mechanism as that of ring-opening polymerization. Accordingly, the present invention can improve the compatibility therebetween, and decrease the reaction time by 50%, and increase the productivity, compared with the other conventional copolymerization methods which have been attempted heretofore. Polyester copolymer prepared according to the present invention can be controlled to have various properties by adjusting the amount of reactants and the reaction condition. Polyester copolymer prepared according to the present invention can replace polyester-nylon copolymer prepared by the conventional polymerization or kneading, and is useful for the production of molded plastic article, vessel, sheet, film, fiber, filament and so on. Besides, the present invention has a merit in that it uses an environmentally favorable recycling process, depolymerizing polyester waste to obtain bis(hydroxyalkyl)ester.

Hereinafter the preferable examples are provided for better understanding of the present invention. However, the present invention is not limited to the following examples.

### EXAMPLE 1

Firstly, molded polyester article was washed, and crushed by crusher to obtain crushed polyester particles, and 50 g of the obtained crushed particles and 100 g of ethylene glycol were placed in a reactor. Then 0.5 g of tetrabutyl titanate as titanium-based catalyst was added into the reactor, and depolymerization reaction was carried out at 290° C. and under 2.0 kgf/cm² for 3 hours while stirring. After completion of the depolymerization, remaining ethylene glycol was removed through distillation tower to obtain bis(hydroxyalkyl)ester. Then, a solution was prepared by adding 30 ml of methylene chloride into 10 g of the obtained bis(hydroxyalkyl)ester, and independently a solution was prepared by mixing 7 g of terephthaloyl chloride and 30 ml of chlorobenzene. The prepared 2 solutions were added into 250 ml of methylenechloride solvent containing 80 g of triethylamine and 300 mg of 1,4-diazabicyclo octane for 30 minutes while being stirred. Wherein, the reactor was maintained at the room temperature. Then, the reaction mixture was further stirred for about 10 minutes, fitered, and washed with aqueous hydrochloride solution and pure water, and filterd again with a phase separation paper, and then the solvent was removed by the vacuum drying method to prepare macrocyclic polyester oligomer.

40 g of the obtained polyester oligomer was transferred into a round flask, and the round flask was maintained in nitrogen atmosphere while maintaining the reactor's internal temperature at 240° C., by circulating nitrogen throughout the round flask by injecting nitrogen under the room pressure and ejecting nitrogen in some amount. Then, 5 g of ε-caprolactam powder, in which 5 wt % of moisture was absorbed, was added into the reaction mixture, and the reaction mixture was stirred at the rate of 30 rpm while maintaining its temperature at 240° C. The stirring rate was maintained at 30 rpm by increasing power of stirrer, considering that the stirring rate decreases with the increase of reaction mixture's viscosity. After 1 hour's reaction, a light yellowish reaction mixture was obtained. The obtained reaction mixture was cooled in a cold water bath, and dried to obtain a product. The molecular weight of the obtained product was measured by GPC, and the result is set forth in Table 1.

### EXAMPLE 2

The product was obtained in the same manner as described in Example 1, except that 10 g of ε-caprolactam powder was added, and after 30 minutes' reaction, 100 ppm of antimony-based catalyst dissolved in ethylene glycol was added into the reactor, and the reaction was further carried out for 1 additional hour. The molecular weight of the obtained product was measured by GPC, and the result is set forth in Table 1.

### EXAMPLE 3

The product was obtained by 1.5 hours' reaction in the same manner as described in Example 2, except that initial reaction was carried out for 30 minutes under nitrogen atmosphere, and antimony-based catalyst was added, and then reaction was further carried out under the atmosphere of 0.1 torr for additional 1 hour. The molecular weight of the obtained product was measured by GPC, and the result is set forth in Table 1.

TABLE 1

| No. | Mw | Mw/Mn |
|---|---|---|
| Example 1 | 85,000 | 2.95 |
| Example 2 | 112,000 | 3.27 |
| Example 3 | 165,400 | 3.12 |

As shown in Table 1, high molecular weight copolymer can be obtained by the polymerization method of Examples 1 to 3, and higher molecular weight copolymer including amide link can be obtained by adding catalyst or under vacuum atmosphere.

1. A method for preparing polyester copolymer containing amide link, wherein the method comprises the step of polymerizing macrocyclic polyester oligomer and cyclic amide monomer.

2. The method for preparing polyester copolymer of claim 1, wherein the macrocyclic polyester oligomer includes the repeating unit of the following formula. 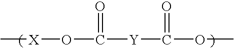
Wherein, X represents alkylene radical or oxyalkylene radical having 2 to 6 carbon atoms, and Y represents aliphatic, aromatic or alicyclic radical, and the number of the repeating unit in the macrocyclic polyester oligomer is 1 to 50.

3. The method for preparing polyester copolymer of claim 1, wherein the macrocyclic polyester oligomer is obtained by reacting bis(hydroxyalkyl)ester with dicarboxylic acid chloride in the presence of unhindered amine.

4. The method for preparing polyester copolymer of claim 3, wherein the bis(hydroxyalkyl)ester is obtained by depolymerizing polyester resin.

5. The method for preparing polyester copolymer of claim 3, wherein the cyclic amide monomer is ε-caprolactam having a cyclic structure and having 2 or more carbon atoms.

6. The method for preparing polyester copolymer of claim 1, wherein the amount of the macrocyclic polyester oligomer is 5 to 99% by weight with respect to total amount of the macrocyclic polyester oligomer and the cyclic amide monomer.
